(19) United States
(12) Patent Application Publication
(10) Pub. No.: US 2012/0299314 A1
(43) Pub. Date: Nov. 29, 2012

(54) DOOR LOCK SENSOR ASSEMBLY

(76) Inventor: Peigen Jiang, Sammamish, WA (US)

(21) Appl. No.: 13/117,812

(22) Filed: May 27, 2011

(51) Int. Cl. E05C 1/08; G01B 7/14

(52) U.S. Cl. 292/137; 324/207.11

(57) ABSTRACT

A door lock assembly capable of sensing its locking status is disclosed which comprises a magnet embedded in a bolt, the bolt being mounted to a door panel, and being able to move between a first position and a second position without a movement of the door panel, when in the first position the bolt being extended into a recess secured to a door frame for locking the door, when in the second position the bolt being retracted out of the recess for unlocking the door, and a magnetic sensor mounted in the recess and configured to detect a presence of the magnet when the magnet being in the first position and to detect an absence of the magnet when the magnet being in the second position.

### BACKGROUND

The present invention relates to door locks, and particularly, to door locks with a sensor for sensing its locking status.

Conventional alarm systems use a magnetic sensor to sense if a door is open or close. In such conventional system, a magnet is mounted either on a door or on a door frame. A magnetic sensor is then mounted on a corresponding position of the door frame or the door, so that when the door is in a closed position, the magnet comes to the vicinity of the magnetic sensor for being sensed thereby. The magnetic sensor may transmit a door status signal, either through a wire or wirelessly, to a remote control unit. Even though the conventional alarm systems can detect whether the door is closed, it cannot detect whether the door is locked.

As such, what is desired is door lock sensor assembly that can detect a lock's locking status and can be easily fitted into conventional locks.

### SUMMARY

The present invention discloses a door lock assembly capable of sensing its locking status. The door lock assembly comprises a magnet embedded in a bolt, the bolt being mounted to a door panel, and being able to move between a first position and a second position without a movement of the door panel, when in the first position the bolt being extended into a recess secured to a door frame for locking the door, when in the second position the bolt being retracted out of the recess for unlocking the door, and a magnetic sensor mounted in the recess and configured to detect a presence of the magnet when the magnet being in the first position and to detect an absence of the magnet when the magnet being in the second position.

Alternatively, the bolt can be ferromagnetic, and the magnetic sensor in the recess can simultaneously generate and detect magnetic field. Then a presence or absence of the ferromagnetic bolt can be detected by the magnetic sensor to represent a locking status of the door lock assembly.

The construction and method of operation of the invention, however, together with additional objects and advantages thereof, will be best understood from the following description of specific embodiments when read in connection with the accompanying drawings.

### BRIEF DESCRIPTION OF THE DRAWING

FIG. 1 is a perspective view of a mounted door lock assembly.

FIG. 2A is a perspective view of a bolt fixed with a magnet according to an embodiment of the present invention.

FIG. 2B is a cross-sectional view of a sensor equipped door lock assembly according to the embodiment of the present invention.

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numbers (if they occur in more than one view) designate the same elements. The invention may be better understood by reference to one or more of these drawings in combination with the description presented herein. It should be noted that the features illustrated in the drawings are not necessarily drawn to scale.

### DESCRIPTION

The following will provide a detailed description of a sensor equipped door lock assembly that can detect the locking status thereof. The sensor equipped door lock assembly is formed by conveniently installing a sensing assembly in a conventional door lock assembly.

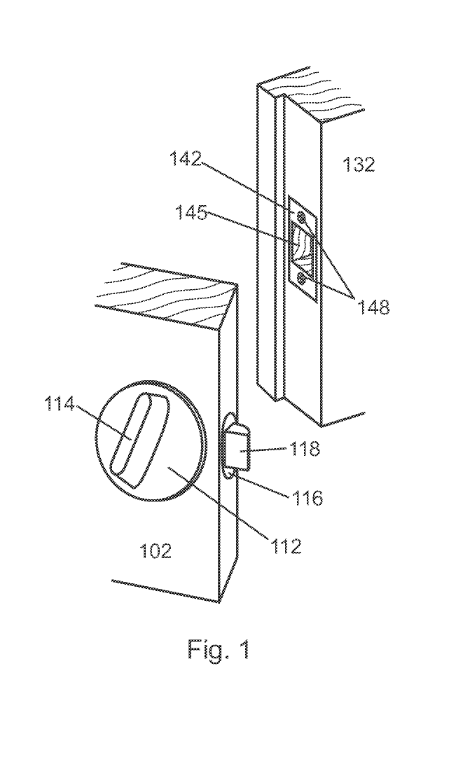

FIG. 1 is a perspective view of a mounted door lock assembly. The door lock assembly comprises a bolt 118 mounted on a door panel 102. The bolt 118 can be retracted into or extended from an aperture of a plate 116 at the turns of a thumbturn 114. The plate 112 is for covering a hole that is drilled in the door panel 102 for accommodating the bolt 118.

Referring again to FIG. 1, a recess 145 is formed on a door frame 132 in a position corresponding to the bolt 118, i.e., when the door panel 102 is closed, the bolt 118 can be extended into the recess 145. The recess 145 is protected by a strike plate 142 having an aperture exposing the recess 145. The strike plate 142 is conventionally fastened to the door frame by screws 148.

The door panel 102 and the door frame 132 are conventionally made of wood material for residential applications, and aluminum for commercial applications. The bolt 118 is typically made of aluminum or brass. Since a goal of the present invention is to add a locking status function to a conventional door lock assembly, a sensing mechanism is retrofitted onto the conventional bolt 118 and in the recess 145 as described in detail below according an embodiment of the present invention.

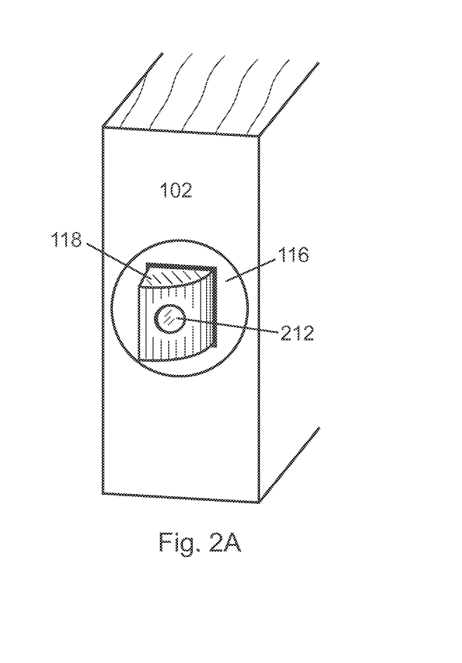

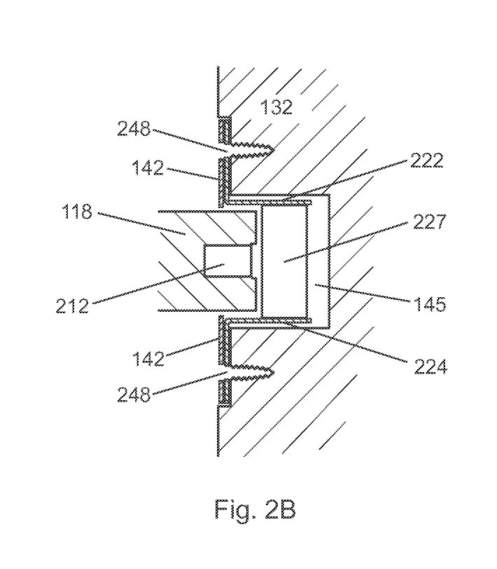

FIG. 2A is a perspective view of the bolt 118 embedded with a magnet 212 according to the embodiment of the present invention. Since the sensing mechanism relies on sensing a presence of a magnet, when the bolt 118 is made of a non-magnetic material, the magnet 212 need to be embedded in the bolt 118. A simple way is to drill a hole at the front end of the bolt 118, and tightly squeeze in the magnet 212 as shown in FIG. 2A. Another way is to drill a hole from a rear end of the bolt 118 (not shown) without drilling through the bolt and insert a magnet (not shown) in the hole to a close to the front end position.

FIG. 2B is a cross-sectional view of a sensor equipped door lock assembly according to the embodiment of the present invention. As the bolt 118 is extended into the recess 145, the lock assembly is in a locked state. The bolt 118 is embedded with a magnet 212, and a magnetic senor 227 is fitted in the recess 145 according to the embodiment of the present invention as shown in FIG. 2B. In the locked state, the magnet 212 comes to the vicinity of the magnetic sensor 227 and can be detected thereby. The magnetic sensor 227 is also configured to generate a first signal corresponding to the locked state and then transmit the first signal to a controller. The signal transmission can be either wired or wireless. In an unlocked state, the magnet 212 is moved away from the recess 145 (not shown). Without detecting the presence of the magnet 212, the magnetic sensor 227 generates a second signal corresponding to the unlocked state and then transmits the second signal to the controller. The first signal may be, for instance, the logic “1”, while the second signal may be the logic “0” on a signal line.

Referring to FIG. 2B again, the magnetic sensor 227 is mounted on a pair of brackets 222 and 224. The brackets 222 and 224 are bended and both have a portion beneath the strike plate 142 for being screw-fastened to the door frame 132 at screw holes 248. The magnetic sensor 227 may be mounted to the brackets 222 and 224 by screws (not shown), and can be situated variably in depth into the recess 145, so that the magnet senor 227 will not be bumped by the bolt 118, yet still be able to detect the locked state.

In essence, the movement of the bolt 118 along with the magnet 212 is to change the magnetic field near the magnetic sensor 227. The change is then detected by the magnetic sensor 227 for determining whether the bolt 118 is in the vicinity of the magnetic sensor 227. Then alternatively, the magnetic sensor 227 can both generate and detect a magnetic field, and the bolt 118 has a ferromagnetic part that can interfere with the magnetic field when in the vicinity of the magnetic sensor 227. However, if the magnetic field in such alternative system is constantly electrically generated by the magnetic sensor 227, power consumption will be too high for a battery operation. A power saving solution is to generate and detect the magnetic field intermittently, i.e., the magnetic field's generating and detecting circuit are activated only for a short period of time in a predetermined time interval. Similarly, detecting the magnet 118 by the magnetic sensor 227 can also be intermittent.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A door lock assembly comprising:
a magnet embedded in a bolt, the bolt being mounted to a door panel, and being able to move between a first position and a second position without a movement of the door panel, when in the first position the bolt being extended into a recess secured to a door frame for locking the door, when in the second position the bolt being retracted out of the recess for unlocking the door; and
a magnetic sensor mounted in a proximity of the recess and configured to detect a presence of the magnet when the magnet being in the first position and to detect an absence of the magnet when the magnet being in the second position.

2. The door lock assembly of claim 1, wherein the magnet is tightly fitted in a hole drilled from a front end of the bolt.

3. The door lock assembly of claim 1, wherein the magnet is tightly fitted in a hole drilled from a rear end of the bolt.

4. The door lock assembly of claim 1, wherein the magnetic sensor detects the presence or absence of the magnet intermittently in a predetermined time interval.

5. The door lock assembly of claim 1, wherein the magnet sensor is inserted in the recess.

6. The door lock assembly of claim 1, wherein the magnetic sensor is mounted on a bracket and the bracket is fastened to the door frame.

7. The door lock assembly of claim 6, wherein the bracket is configured to allow the magnetic sensor's depth into the recess to be adjustable.

8. The door lock assembly of claim 1 further comprising a signal generator configured to generate a signal representing a locking status of the door lock assembly.

9. The door lock assembly of claim 8, wherein the signal generator transmits the locking status signal either wirelessly or through a wire to a controller.

10. The method for detecting a locking status of a door lock assembly, the method comprising:
embedding a magnet in a bolt, the bolt being mounted to a door panel and being able to move between a first position and a second position without a movement of the door panel, when in the first position the bolt being extended into a recess secured to a door frame for locking the door, when in the second position the bolt being retracted out of the recess for unlocking the door; and
detecting a presence in a close proximity of the magnet from a location proximate to the recess.

11. The method of claim 9, wherein the magnet is tightly fitted in a hole drilled from a front end of the bolt.

12. The method of claim 9, wherein the magnet is tightly fitted in a hole drilled from a rear end of the bolt.

13. The method of claim 9, wherein the detecting is performed intermittently in a predetermined time interval.

14. The method of claim 9 further comprising generating a signal representing a locking status of the door lock assembly.

15. The method of claim 14 further comprising transmitting the locking status signal either wirelessly or through a wire to a controller.

16. A door lock assembly comprising:
a bolt having a ferromagnetic material, the bolt being mounted to a door panel, and being able to move between a first position and a second position without a movement of the door panel, when in the first position the bolt being extended into a recess secured to a door frame for locking the door, when in the second position the bolt being retracted out of the recess for unlocking the door; and
a magnetic sensor mounted in a proximity of the recess and configured to detect a change in magnetic field.

17. The door lock assembly of claim 16, wherein the magnetic sensor is mounted on a bracket and the bracket is fastened to the door frame.

18. The door lock assembly of claim 17, wherein the bracket is configured to allow the magnetic sensor's depth into the recess to be adjustable.

19. The door lock assembly of claim 16, wherein the magnetic sensor is inserted in the recess.

20. The door lock assembly of claim 16 further comprising a magnetic field generator.

21. The door lock assembly of claim 20, wherein the magnetic sensor and magnetic field generator are activated intermittently and synchronously in a predetermined time interval.

22. The door lock assembly of claim 16 further comprising a signal generator configured to generate a signal representing a locking status of the door lock assembly.

23. The door lock assembly of claim 22, wherein the signal generator transmits the locking status signal either wirelessless or through a wire to a controller.
